(19) United States
(12) Patent Application Publication
(10) Pub. No.: US 2007/0003354 A1
(43) Pub. Date: Jan. 4, 2007

(54) Printer

(75) Inventors: Yukihiro Tamura, Kanagawa (JP); Osamu Watanabe, Shizuoka (JP); Hiroyasu Ishii, Shizuoka (JP); Teruyuki Ochiai, Shizuoka (JP); Katsumi Gocho, Shizuoka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/446,845

(22) Filed: Jun. 5, 2006

(30) Foreign Application Priority Data
Jun. 6, 2005 (JP) 2005-165044

(51) Int. Cl. B41J 11/00

(52) U.S. Cl. 400/621

(57) ABSTRACT

A cutter unit including a cutter for cutting long paper in a direction orthogonal to a paper feeding direction is disposed on one side of a printer body provided with a printing mechanism. A cover is attached to the printer body so as to cover an outer surface of the cutter unit. The cutter unit and the cover are independently pivotable.

### CROSS-REFERENCE TO RELATED APPLICATION

The present application is based on and claims the benefit of priority of Japanese Patent Application P2005-165044 filed on Jun. 6, 2005, the entire contents of which are incorporated herein by reference.

### BACKGROUND OF THE INVENTION

1. Field of the Invention

The present invention relates to a printer having a cutter, which cut long paper into a predetermined length, and issuing the cut paper.

2. Description of Related Art

Generally, in a bar code printer or the like, a consideration is given so that the issued form of paper after printing can be changed in order to meet various users' demands. There are three paper issuance forms, which are “continuous issue,” “cut issue,” and “label issue.” “Continuous issue” means to issue printed long paper in an as-suspended state or in a wound-up state. “Cut issue” means to cut long paper into a certain length with a cutter and issue a sheet-like printed matter. “Label issue” means to print data onto the label sheets stuck on a long base paper, and thereafter peel off the label sheets one by one from the base paper.

Japanese laid-open Patent Publication No. Hei 08 (1996)-258827 discloses a label printer having both “continuous issue” and “label issue” functions. When “continuous issue” is selected, paper having been printed is delivered and wound up. In the case of “label issue”, base paper is bent abruptly to peel off and issue label sheets. In the label printer disclosed in the above Publication, when the function of “cut issue” is required, it can be attained by optionally attaching a cutter unit to the printer. Generally, the cutter unit is fixed with screws to the interior of the printer body. Another mounting structure for mounting the cutter unit is disclosed in Japanese laid-open Patent Publication No. Hei 10 (1998)-100493. According to the structure disclosed therein, a cover disposed on a paper issuing side of a printer body is constructed to be openable and closable, and a cutter unit is attached to the cover to attain the function of “cut issue.” Various cutter structures are available. For example, in Japanese laid-open Patent Publication No. 2004-351558, there is disclosed a so-called guillotine cutter including a movable cutting edge and a rectilinear fixed cutting edge. The movable cutting edge can advance and retreat relative to the fixed cutting edge.

In the printer having “cut issue” function, as noted above, the cutter unit is attached fixedly to the printer body or is attached integrally to the cover which is mounted for opening and closing with respect to the printer body. However, paper dust may stay in the cutter portion or an adhesive for sticking labels to the base paper may adhere to the cutter portion, with a consequent likelihood of paper clogging. Cleaning of the cutter portion is needed to solve this problem. To clean the cutter portion, it is necessary to remove the cutter unit from the printer body or dismantle the cutter portion. Thus, the workability is very poor and the use of a tool is always required.

In case of using a cutter of the structure disclosed in Japanese laid-open Patent Publication No. 2004-351558, since a movable cutting edge is actuated by a motor, there is a possibility that the movable cutting edge may start moving suddenly during the cleaning work for the cutter portion. Thus, the structure disclosed therein is unsatisfactory from the viewpoint of safety.

Accordingly, an object of the present invention is to facilitate maintenance of a cutter portion.

### SUMMARY OF THE INVENTION

To achieve the object of the present invention, a printer is provided which includes: (i) a printer body including a case, (ii) a printing mechanism installed within the printer body to print data onto long paper, (iii) a cutter unit including a cutter disposed on one side of the printer body to cut the paper, after printing by the printing mechanism, in a direction orthogonal to a feed direction of the paper, (iv) a cover disposed on the one side of the printer body so as to cover the cutter unit, and (v) a pivot member for mounting the cutter unit and the cover each independently pivotable with respect to the printer body.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view of a printer body in an embodiment of the present invention;

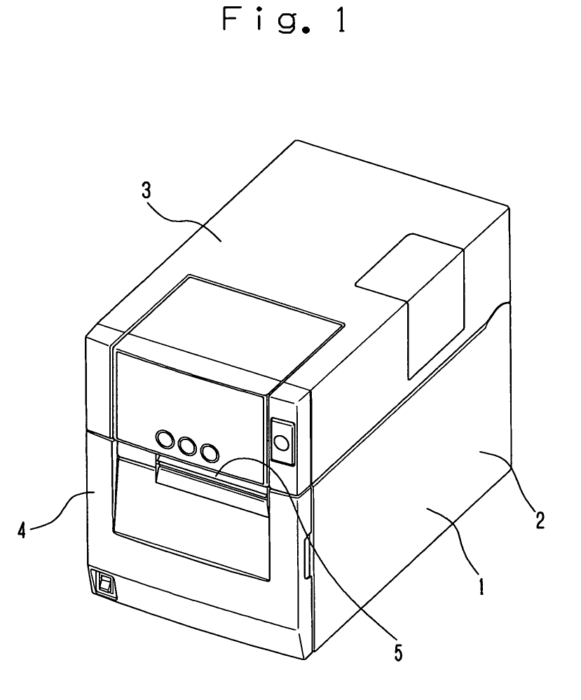

FIG. 2 is a front view of a cutter unit;

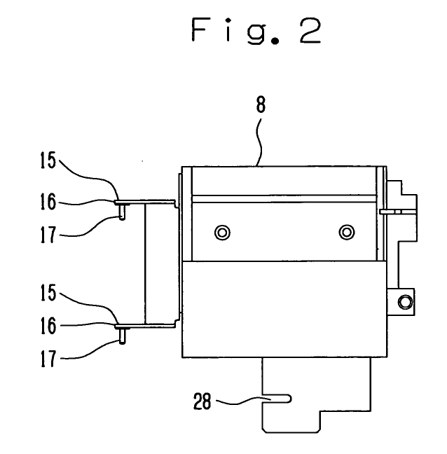

FIG. 3 is a perspective view of the printer body in a state in which a cutter unit and a cover are removed from a lower case of the printer body;

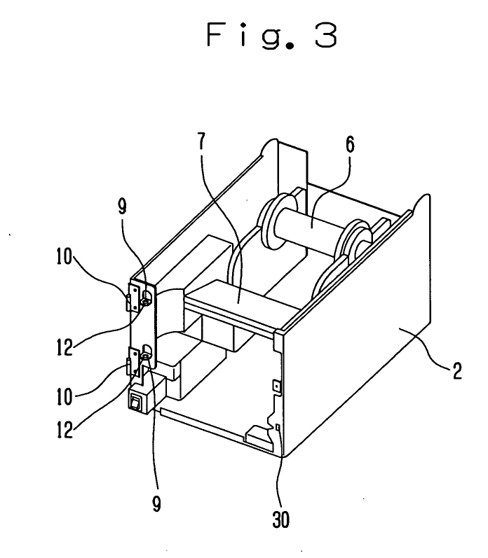

FIG. 4 is a perspective view of the printer body with only the cover opened;

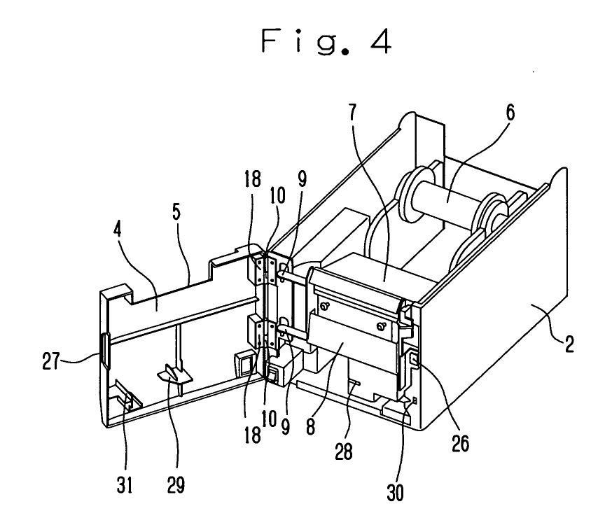

FIG. 5 is a perspective view of the printer body with both cover and cutter unit opened;

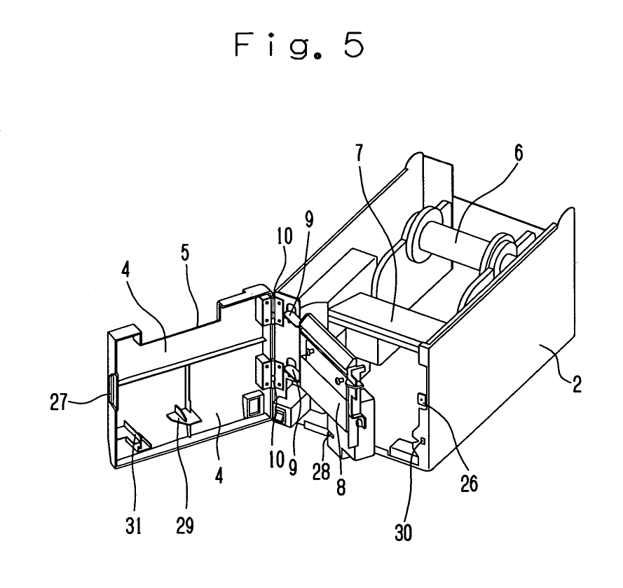

FIG. 6 is a perspective view of a pivot member for mounting the cutter unit to the lower case; and

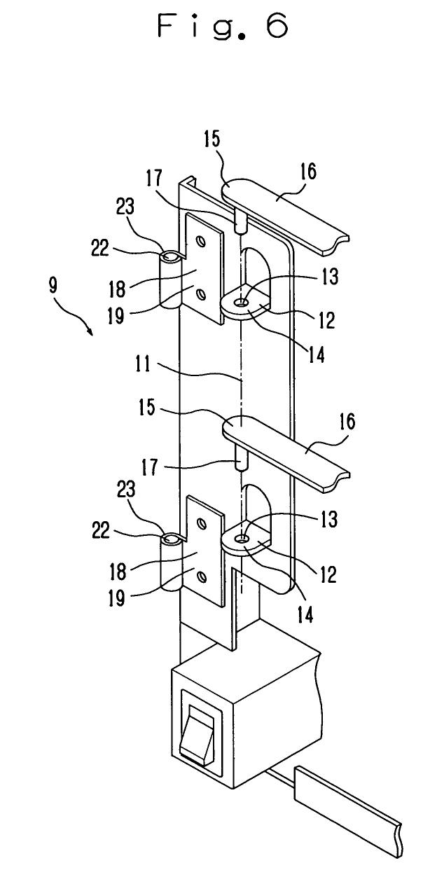

FIG. 7 is a perspective view of a pivot member for mounting the cover to the lower case.

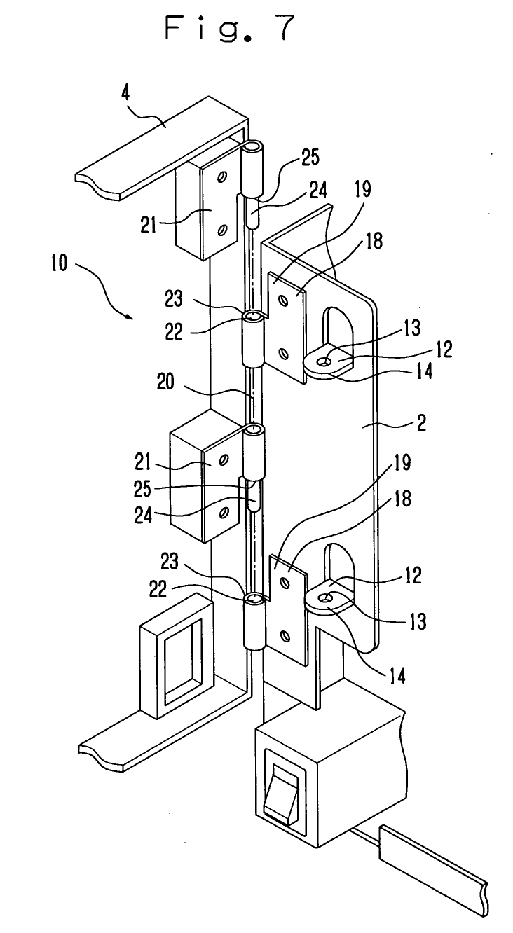

### DETAILED DESCRIPTION OF THE PREFERRED EMBODIMENTS

An embodiment of the present invention will be described hereinafter with reference to the accompanying drawings. A printer body 1 having a bar code printing function is rectangular parallelepiped in its entire shape and is made up of a lower case 2 whose upper side is open and an upper case 3 hinged to the lower case 2 so as to open and close the upper side of the lower case 2. A cutter cover 4 as a cover is attached to one side of the lower case 2 by a structure which will be described later. A paper discharge port 5 for discharge of printed paper is formed between an upper edge of the cutter cover 4 and the upper case 3. A paper holder 6, which holds a roll of long paper (not shown), is attached to the lower case 2 so as to be detachable upward. A printing mechanism 7 for printing a necessary matter, e.g., bar code, onto the paper is provided in the printer body 1. The printing mechanism 7 comprises a printer head (not shown) and a platen (not shown). The printer head is disposed on the upper case 3. The platen is disposed on the lower case 2. Though not specially shown, the printing mechanism 7 is hinged at one end thereof so that it can rise to provide a paper stretching space when the paper is loaded.

In the lower case 2 there are provided the cutter cover 4 and a cutter unit 8 which is disposed in proximity to the paper discharge port 5 to cut the paper into a predetermined length. The cutter cover 4 and the cutter unit 8 are provided so as to be pivotable in the horizontal direction about vertical pivot members 9 and 10, respectively. More specifically, on one side of the lower case 2, two bearings 12, each of which is a part of the pivot member 9, are cut and raised so as to be positioned on a vertical line 11. The bearings 12 are spaced a predetermined distance from each other, and a shaft hole 13 is formed at a center of each of the bearings 12. Upper surfaces of the bearings 12 are formed as bearing surfaces 14 for bearing a load. The cutter unit 8 has two shaft portions 15 spaced apart with the same spacing as the two bearings 12. The shaft portions 15 are each made up of a planar projection 16 which abuts against an upper surface of the associated bearing surface 14 and a shaft 17 of a predetermined length projecting downward from the projection 16 to be fitted in the associated shaft hole 13. When the shafts 17 of the unit 8 are positioned on the vertical line 11 and is moved downward, the shafts 17 are fitted in the shaft holes 13 and the projections 16 come into abutment against the bearing surface 14 of the bearings 12. The mounting of the cutter unit 8 is now over. Thus,. the mounting of the cutter unit 8 can be done without using any tool and the cutter unit 8 can be removed easily by reverse operations.

In the lower case 2, moreover, the pivot member 10 is disposed in proximity to the pivot member 9. The pivot member 10 is formed by hinges 18. Two hinge pieces 19 which constitute the hinges 18 are fixed to the lower case 2 and are spaced a predetermined distance from each other on a vertical line 20, while two other hinge pieces 21 are attached to the cutter cover 4 with the same spacing as the hinge pieces 19 on the vertical line 20. The hinge pieces 19 are each formed with a shaft hole 22 and a bearing surface 23, while the hinge pieces 21 are each formed with a shaft 24 for fitting into the shaft hole 22 and an abutting surface 25 for abutment against the bearing surface 23. To couple the cutter cover 4 to the lower case 2, the shafts 24 of the cutter cover 4 are positioned onto the vertical line 20 and are inserted into the shaft holes 22 from above, whereby the abutting surfaces 25 come into abutment against the bearing surfaces 23 and the cutter cover 4 is mounted. The cutter cover 4 can be removed by performing reverse operations.

The cutter cover 4 and the cutter unit 8 thus mounted are each pivotable independently relative to the lower case 2, and when closed, they cover one side of the lower case 2 in a mutually overlapped state. A hook 27 is formed on a free end side of the cutter cover 4. The hook 27 is adapted to engage and disengage a retaining pawl 26 formed on the side of the lower case 2 and, unless opened manually, it maintains a locked state relative to the lower case 2. A manually rotatable fixing screw (not shown) is attached to the free end side of the cutter unit 8 to fix the cutter unit to the lower case 2.

Such a guillotine cutter as is described in Japanese laid-open Patent Publication No. Hei 10 (1998)-100493 is attached to the cutter unit 8 although an explanation of its detailed structure is omitted. With this cutter, paper which passes through the paper discharge port 5 after printing can be cut into a desired length. An interlock switch 28 (first switch) is disposed under a nearly central portion of the cutter unit 8. The interlock switch 28 is for turning ON and OFF a power supply for driving the cutter, which is driven by a motor. The interlock switch 28 is OFF in a free state thereof. A lug 29 for interference with the interlock switch 28 is formed on the cutter cover 4. When the cutter cover 4 is closed, the lug 29 actuates the interlock switch 28 to turn ON the power supply of the cutter. A photosensor 30 adapted to operate photoelectrically is provided in the lower case 2 and a lug 31 for interference with the photosensor 30 is formed on the cutter cover 4. The photosensor 30 functions to not only control ON and OFF of the entire power supply but also check whether the cutter cover 4 is closed or not. When the cutter cover 4 is closed, the lug 31 interferes with the photosensor 30, whereby the state of the cutter cover 4 is detected.

Further, there is provided a second switch for detecting whether the cutter cover 4 is open or closed.

In using the printer constructed as above, the upper case 3 is opened to expose the upper side of the lower case 2, then the rolled paper is loaded to the paper holder 6 and the paper holder 6 is mounted in the lower case 2. The printing mechanism 7 is opened and the paper is positioned in a predetermined paper passage, then the printing mechanism is set again to its normal position, and the upper case 3 is then closed. Then, part of the paper is drawn out from the paper discharge port 5. Preparations before printing are now completed. In this state, while printing the paper, the paper is cut into a predetermined length with the cutter of the cutter unit 8 to effect a printing work. As this state of use is continued for a long time, paper dust stays in the cutter portion or an adhesive of the label sheets affixed to the base paper adheres to the cutter portion. Consequently, there may occur a state in which the feeding of paper is not performed smoothly. In such a case, the cutter cover 4 is opened, then the cutter unit 8 is opened and cleaning of the cutter portion is performed. Cleaning of the cutter portion is easy to perform because both surfaces of the cutter are open. Therefore, paper dust and adhesive can be removed completely by accessing the other surface. Moreover, upon opening of the cutter cover 4, the photosensor 30 operates and turns OFF the power supply. Opening the cutter unit 8 actuates the interlock switch 28 to turn OFF the power supply for the cutter. As a result, there is no danger of the cutter operating suddenly during the cleaning work. Since the danger is avoided by a double safety measure, an extremely high safety is ensured. Particularly, even in the event that a portion of the photosensor 30 is hidden by a finger, the double safety measure is effective because the cutter of the cutter unit 8 is controlled by the interlock switch 28.

Further, as described above, the cutter cover 4 and the cutter unit 8 can be removed from the lower case 2 by merely pulling them upward without using any tool, and in their removed state it is possible to perform cleaning of the cutter. In case of performing a work without using the cutter, the work can be done in a simple manner by removing only the cutter unit 8. Thus, it is possible to facilitate the work in case of handling the cutter as an optional item.

In this embodiment, as described above, the cutter unit 8 having the cutter for cutting the long paper in a direction orthogonal to the paper feed direction is provided on one side of the printer body 1, which is a rectangular parallelepiped in shape, and which is provided with the printing mechanism for printing the paper. The cutter cover 4 is attached to the printer body 1 so as to cover the outer surface of the cutter unit 8, and the vertical pivot members 9 and 10 for holding the cutter unit 8 and the cutter cover 4 such that each is independently pivotable are positioned in proximity to each other. Consequently, when the paper feed encounters any trouble due to the adhesion of paper dust or adhesive to the cutter, it is possible to open the cutter unit 8 and clean the cutter from both sides of the cutter unit and thus the cleaning work becomes extremely easy.

Moreover, the pivot members 9 and 10 of the cutter unit 8 and the cutter cover 4 respectively are made up of the shaft holes 13, 22 and the shaft portions 15, 24, which are adapted for mutual engagement and disengagement by vertical movements, and are provided with stepped portions comprising the vertically positioning bearing surfaces 14, 23 and projections 16 or abutting surfaces 25. Therefore, the mounting and removal of the cutter unit 8 and the cutter cover 4 can be done extremely easily without using any tool.

Further, since the opening/closing sensors comprising the interlock switch 28 and the photosensor 30 for detecting open/close conditions of the cutter unit 8 and the cutter cover 4 respectively are disposed separately, it is possible to avoid the danger of the cutter starting to move suddenly during the cleaning work; thus, safety is doubly ensured.

Obviously, numerous modifications and variations of the present invention are possible in light of the above teachings. It is therefore to be understood that within the scope of the appended claims, the invention may be practiced otherwise than as specifically described herein.

What is claimed is:

1. A printer comprising:
a printer body including a case;
a printing mechanism installed within the printer body to print data onto long paper;
a cutter unit including a cutter disposed on one side of the printer body to cut the paper, after printing by the printing mechanism, in a direction orthogonal to a feed direction of the paper;
a cover disposed on the one side of the printer body so as to cover the cutter unit; and
a pivot member for mounting the cutter unit and the cover such that each is independently piovotable with respect to the printer body.

2. A printer according to claim 1, wherein the pivot member includes: (i) a shaft hole and a shaft portion which are vertically movable with respect to each other to effect mounting and removal of the cutter unit, and (ii) a stepped portion for downward positioning.

3. A printer according to claim 1, wherein the pivot member includes: (i) a shaft hole and a shaft portion which are vertically movable with respect to each other to effect mounting and removal of the cover, and (ii) a stepped portion for downward positioning.

4. A printer according to claim 1, further comprising a first switch for detecting whether the cutter unit is open or closed.

5. A printer according to claim 4, further comprising a second switch for detecting whether the cover is open or closed.

6. A printer according to claim 1, further comprising a switch for detecting whether the cover is open or closed.

7. A printer according to claim 1, further comprising a paper holder for holding a roll of long paper so as to accommodate the paper in the printing body.

8. A printer according to claim 1, wherein the cover and the cutter unit are individually attached to and detached from the printer body.

9. A printer according to claim 1, wherein the cutter unit comprising guillotine cutter.
